(19) United States
(12) Patent Application Publication
(10) Pub. No.: US 2006/0044251 A1
(43) Pub. Date: Mar. 2, 2006

(54) Flat display device and method of driving the same

(76) Inventors: Hirofumi Kato, Fukaya-shi (JP); Yasuhiro Yamashita, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/204,182

(22) Filed: Aug. 16, 2005

(30) Foreign Application Priority Data
Aug. 26, 2004 (JP) 2004-246842
May 25, 2005 (JP) 2005-152359

(51) Int. Cl. G09G 3/36

(52) U.S. Cl. 345/98

(57) ABSTRACT

A flat display device including a plurality of pixels arranged in matrix on a substrate, a plurality of scanning lines provided for respective rows of the pixels, which select a group of pixels in each of the rows, a scanning line driving circuit to which the scanning lines are connected, and a scanning switching circuit which determines whether input original image data is a still image or a moving image and switches an operation of the scanning line driving circuit to one of interlaced scanning and noninterlaced scanning in accordance with a determination result.

### CROSS-REFERENCE TO RELATED APPLICATIONS

This application is based upon and claims the benefit of priority from prior Japanese Patent Applications No. 2004-246842, filed Aug. 26, 2004; and No. 2005-152359, filed May 25, 2005, the entire contents of both of which are incorporated herein by reference.

### BACKGROUND OF THE INVENTION

1. Field of the Invention

The present invention relates to a flat display device. More specifically, the invention relates to a flat display device including a display panel and an information processing unit connected to the display panel, and a method of driving the flat display device.

2. Description of the Related Art

A flat display device generally includes pixels arranged in matrix on a display section, a plurality of signal lines that supply an image signal to a group of pixels in each column, a signal line driving circuit to which the signal lines are connected, a plurality of scanning lines that select a group of pixels in each row, and a scanning line driving circuit to which the scanning lines are connected.

When the scanning line driving circuit selects a scanning line, an image is displayed on a pixel located where the selected scanning line crosses its corresponding signal line.

Conventionally, the prior art flat display device adopts noninterlaced scanning in which the scanning line driving circuit selects scanning lines in sequence. However, a portable personal computer (referred to as a PC hereinafter) with such a flat display device requires a long-time driving using a battery when it is used outdoors, on the move and the like. In noninterlaced scanning, however, one frame is formed of one screen, or the scanning line driving circuit drives all scanning lines within one frame, and an information processing unit transmits all line image information from one frame. Data transfer speed therefore becomes high, and power consumption is difficult to lower.

To resolve the above problem, Jpn. Pat. Appln. KOKAI Publication No. 2001-282204 discloses a display device including a display section having first and second display areas on which images are displayed independently of each other. In this display device, at least the first display area is interlaced-scanned.

Most PCs are generally used for word processing, drawing and the like and, in this case, still images are usually displayed on the flat display device. The opportunity to display moving images of television, movies, etc. has recently been increased. If interlaced scanning in which a displayed image is formed of a plurality of fields is performed when a high-speed response is required to display, e.g., a moving image, it causes a problem that the blur of the image is easily emphasized.

The above-described flat display device has the following problems. A moving image decreases in quality due to interlaced scanning performed when the moving image is displayed. Power consumption increases due to noninterlaced scanning performed when a still image is displayed.

### BRIEF SUMMARY OF THE INVENTION

The present invention has been developed in consideration of the above problems and its object is to provide a flat display device capable of low power consumption without decreasing the quality of a displayed image and a method of driving the flat display device.

According to a first aspect of the present invention, there is provided a flat display device comprising a plurality of pixels arranged in matrix on a substrate, a plurality of scanning lines provided for respective rows of the pixels, which select a group of pixels in each of the rows, a scanning line driving circuit to which the scanning lines are connected, and a scanning switching circuit which determines whether input original image data is a still image or a moving image and switches an operation of the scanning line driving circuit to one of interlaced scanning and noninterlaced scanning in accordance with a determination result.

According to a second aspect of the present invention, there is provided a method of driving a flat display device including a plurality of pixels arranged in matrix on a substrate, a plurality of signal lines provided for respective columns of the pixels, which supply an image signal to a group of pixels in each of the columns, a plurality of scanning lines provided for respective rows of the pixels, which select a group of pixels in each of the rows, a signal line driving circuit to which the signal lines are connected, a scanning line driving circuit to which the scanning lines are connected, and a scanning switching circuit to which original image data is input, the method comprising determining whether the original image data is a still image or a moving image in the scanning switching circuit, and switching an operation of the scanning line driving circuit to one of interlaced scanning and noninterlaced scanning in accordance with a determination result.

According to the above flat display device and the above method of driving the same, low power consumption can be achieved without decreasing the quality of a displayed image.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a configuration of a flat display device according to a first embodiment of the present invention;

FIG. 2 is a block diagram showing a configuration of a display image control unit of an information processing unit of the flat display device shown in FIG. 1;

FIG. 3 is an illustration of a method of determining a moving image or a still image in the display image control unit shown in FIG. 2;

FIG. 4 is a timing chart of drive signals transmitted to scanning lines when a switching unit of the flat display device shown in FIG. 1 causes a scanning-line driving circuit to noninterlaced-scan the scanning lines;

FIG. 5 is another timing chart of drive signals transmitted to the scanning lines when the switching unit of the flat display device shown in FIG. 1 causes the scanning-line driving circuit to interlaced-scan the scanning lines;

FIG. 6 is a diagram showing an example of interlaced scanning to form one screen of two fields;

FIG. 7 is a timing chart of drive signals transmitted to the scanning lines when one screen is formed of three fields;

FIG. 8 is a diagram showing an example of interlaced scanning to form one screen of three fields;

FIG. 9 is a flowchart showing an operation of an interlaced/noninterlaced switching unit performed when one of interlaced-scanning ON and OFF signals is selected during the vertical blanking interval;

FIG. 10 is a diagram showing an example of display on a flat display device according to a second embodiment of the present invention;

FIG. 11 is a timing chart of drive signals transmitted to the scanning lines when one of interlaced-scanning ON and OFF signals is selected during a horizontal blanking interval;

FIG. 12 is a diagram showing an example of display of interlaced scanning performed as shown in FIG. 11;

FIG. 13 is a flowchart showing of an operation of the switching unit performed when one of interlaced-scanning ON and OFF signals is selected during the horizontal blanking interval;

FIG. 14 is a block diagram showing a configuration of a display image control unit of a flat display device according to a third embodiment of the present invention;

FIG. 15 is an illustration of a method of determining a moving image in a moving-image determination circuit of the flat display device according to the third embodiment of the present invention;

FIG. 16 is a timing chart of pulses transmitted to scanning lines in interlaced scanning to form one screen of two fields; and

FIG. 17 is a flowchart showing a determination operation of the display image control unit and a selection operation of a timing controller in the flat display device according to the third embodiment of the present invention.

### DETAILED DESCRIPTION OF THE INVENTION

A flat display device according to a first embodiment of the present invention will be described with reference to the accompanying drawings.

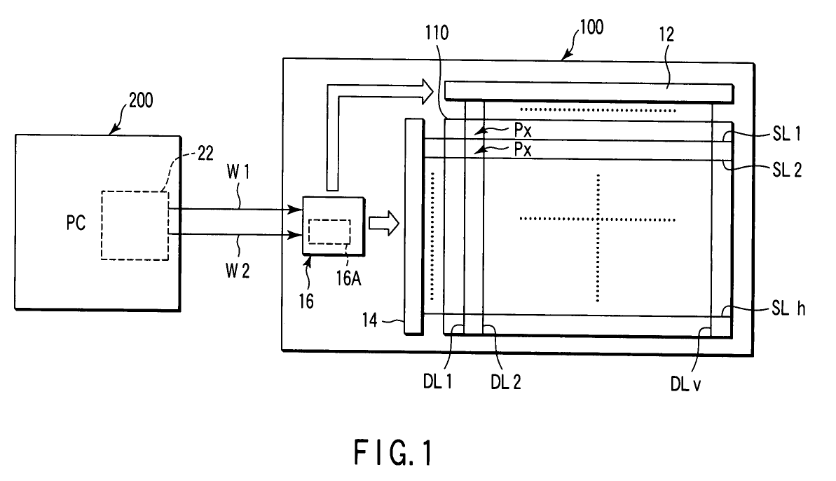

Referring to FIG. 1, the flat display device comprises a display panel 100 and an information processing unit 200. The display panel 100 includes a display section 110 having a plurality of pixels PX arranged in matrix. The display panel 100 and the information processing unit 200 are electrically connected to each other by signal supply wires W1 and W2.

The display section 110 has a plurality of signal lines DL (DL1 to DLv) provided for their respective columns of the pixels PX. The signal lines DL are connected to a signal line driving circuit 12 provided outside the display section 110 to supply image signals to the pixels of each of the columns. The display section 110 also has a plurality of scanning lines SL (SL1 to SLh) provided for their respective rows of the pixels PX. The scanning lines SL are connected to a scanning line driving circuit 14 provided outside the display section 110 to turn on/off the pixels of each of the rows electrically.

The signal line driving circuit 12 and the scanning line driving circuit 14 are connected to a scanning switching circuit. The scanning switching circuit includes a switching unit 16A and a display image control unit 22. The switching unit 16A is included in a timing controller 16 provided outside the display section 110. The display image control unit 22 is included in the information processing unit 200 and connected to the switching unit 16A through the signal supply wires W1 and W2. The signal line driving circuit 12 and the scanning line driving circuit 14 are controlled in response to drive signals from the scanning switching circuit.

The display image control unit 22 is supplied with original image data Si(t) and a first sync signal SiA. The unit 22 determines whether the original image data Si(t) is a moving image or a still image and supplies the switching unit 16A with image data Si1, a second sync signal SiB and an interlaced-scanning ON/OFF signal Si2 in accordance with the determination result.

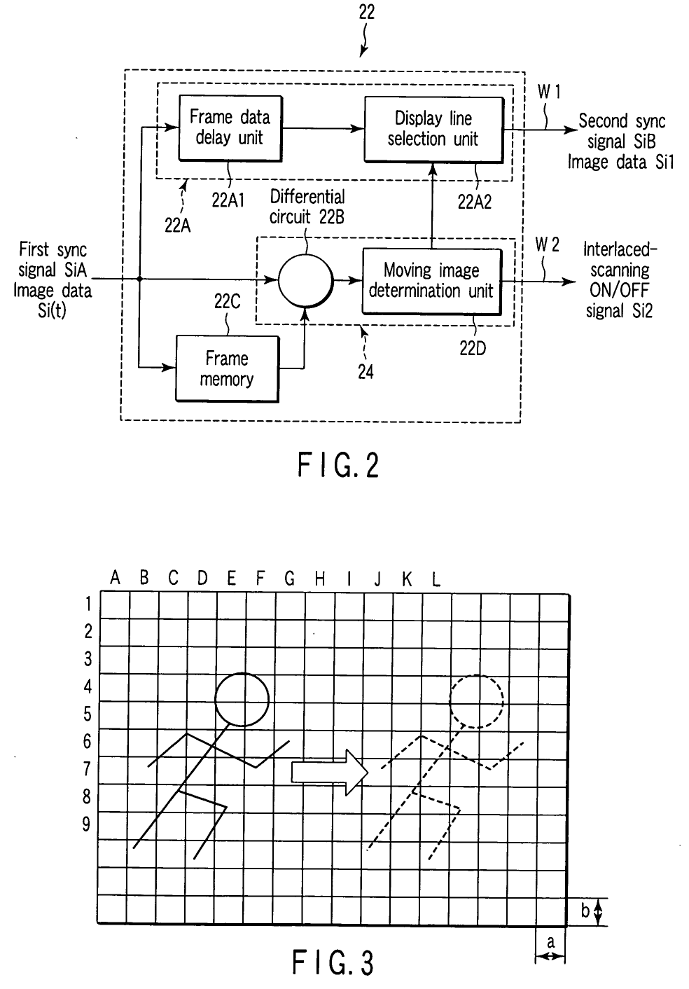

Referring to FIG. 2, the display image control unit 22 includes a data conversion circuit 22A, a frame memory 22C and a determination unit 24. The determination unit 24 has a differential circuit 22B and a moving image determination unit 22D.

The original image data Si(t) input to the display image control unit 22 is supplied to the data conversion circuit 22A, differential circuit 22B and frame memory 22C. The differential circuit 22B calculates a difference between the input original image data Si(t) and one-frame-old original image data Si(t-1) stored in the frame memory 22C, and outputs the difference.

The output of the differential circuit 22B is supplied to the moving image determination unit 22D. The unit 22D has an adder circuit and a moving image determination circuit. The adder circuit calculates a sum of differences for one frame. A calculation result of the adder circuit is input to the moving image determination circuit.

The moving image determination circuit determines that the original image data Si(t) is a moving image when the input signal exceeds a given value, while it determines that the original image data Si(t) is a still image when the input signal is not larger than the given value.

In accordance with the results so determined, the moving image determination unit 22D transmits the interlaced-scanning ON/OFF signal Si2 to the switching unit 16A of the timing controller 16 and the data conversion circuit 22A. If the unit 22D determines that the original image data Si(t) is a still image, it transmits the signal Si2 as an ON(H) signal. If it determines that the data Si(t) is a moving image, it transmits the signal Si2 as an OFF(L) signal.

The data conversion circuit 22A includes a frame data delay unit 22A1 and a display line selection unit 22A2. The unit 22A2 selects image data Si1 corresponding to scanning lines SL to be driven from the original image data Si(t) received from the unit 22A1. In other words, when the original image data Si(t) is a still image, the moving image determination unit 22D supplies the unit 22A2 with the ON signal of the interlaced-scanning ON/OFF signal Si2. Then, the unit 22A2 selects image data Si1 corresponding to scanning lines (e.g., SL1, SL3, SL5, . . .) to be driven from the original image data Si(t).

When the original image data Si(t) is a moving image, the moving image determination unit 22D supplies the display line selection unit 22A2 with the OFF signal of the signal Si2. Then, the unit 22A2 selects image data Si1 corresponding to all of the scanning lines SL, or determines the original image data Si(t) as image data Si1. The image data Si1 output from the unit 22A2 is sent to the switching unit 16A through the signal supply wire W1.

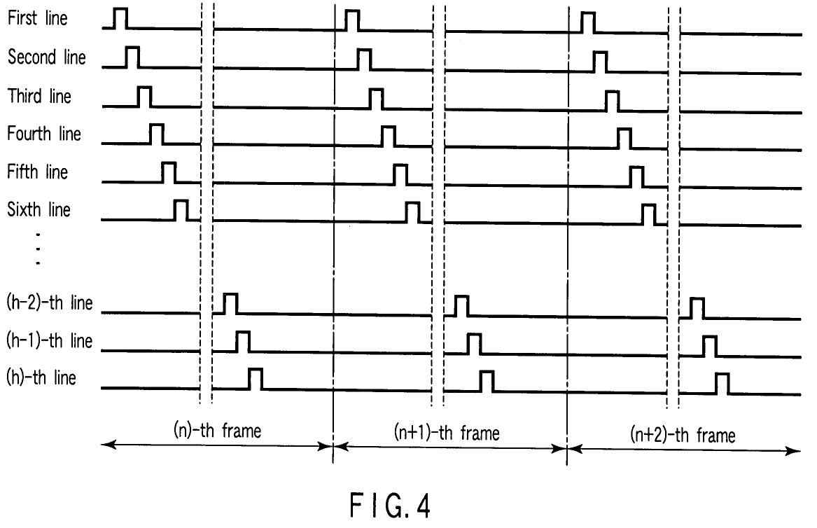

The switching unit 16A causes the scanning line driving circuit 14 to noninterlaced-scan the scanning lines SL, as shown in FIG. 4, when the received interlaced-scanning ON/OFF signal Si2 is an OFF(L) signal or when the original image data Si(t) is a moving image. Then, the switching unit 16A supplies the signal line driving circuit 12 with image data Si1 corresponding to all of the scanning lines SL and supplies the scanning line driving circuit 14 with a drive signal in response to the sync signal SiB.

The switching unit 16A causes the scanning line driving circuit 14 to interlaced-scan the scanning lines SL when the received interlaced-scanning ON/OFF signal Si2 is an ON(H) signal, or when the original image data Si(t) is a still image. Then, the switching unit 16A supplies the signal line driving circuit 12 with image data Si1 corresponding to scanning lines SL to be driven and supplies the scanning line driving circuit 14 with a drive signal in response to the sync signal SiB.

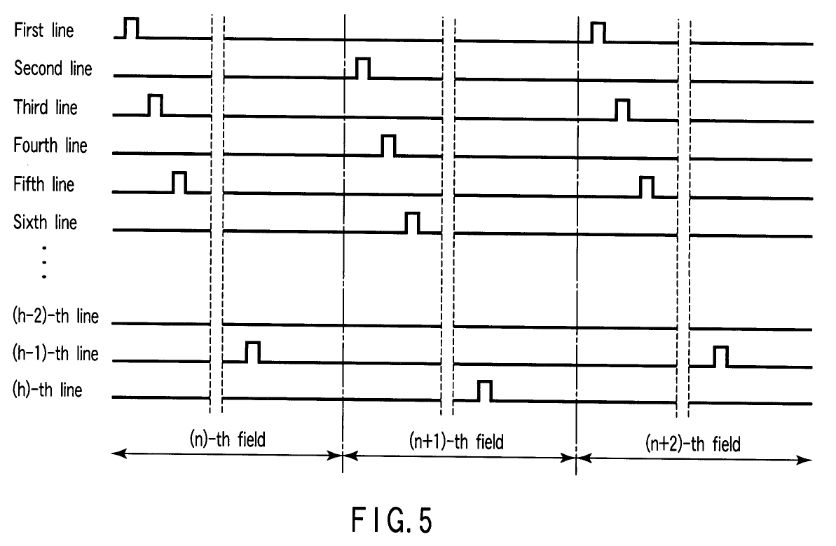

As shown in FIG. 5, the scanning line driving circuit 14 transmits drive signals to the odd-numbered scanning lines SL1, SL3, SL5, . . . in an (n)-th field. The signal line driving circuit 12 supplies the signal lines DL with image data Si1 corresponding to the odd-numbered scanning lines.

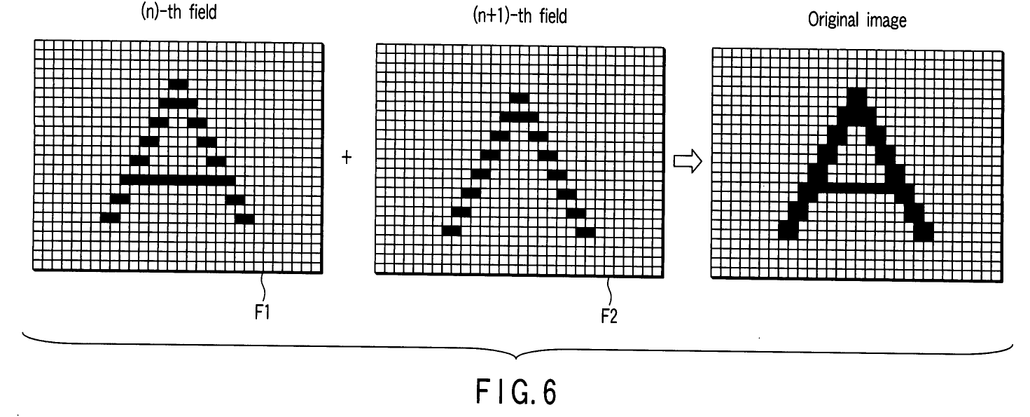

The scanning line driving circuit 14 transmits drive signals to the even-numbered scanning lines SL2, SL4, SL6, . . . in the (n+1)-th field. The signal line driving circuit 12 supplies the signal lines DL with image data Si1 corresponding to the even-numbered scanning lines. If the circuit 14 interlaced-scans the scanning lines as described above, one screen is formed of two fields as shown in FIG. 6. In FIG. 6, a character image of “A” is formed of the (n)-th field F1 and the (n+1)-th field F2, and displayed.

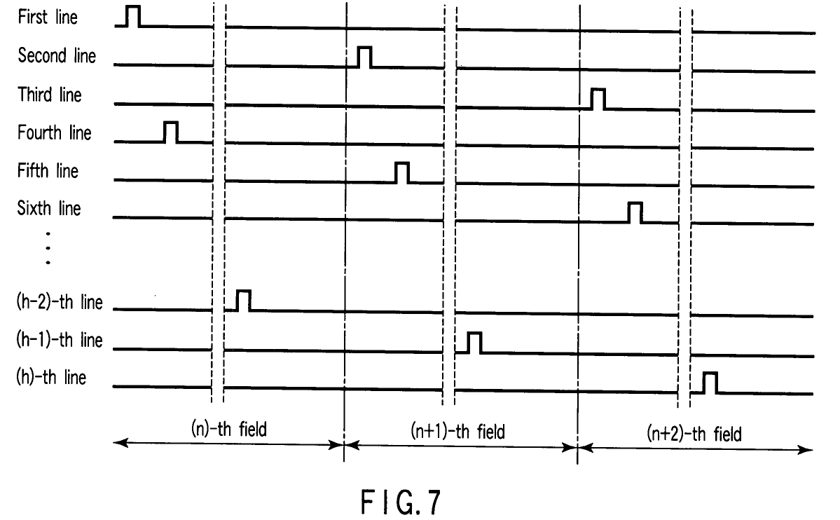

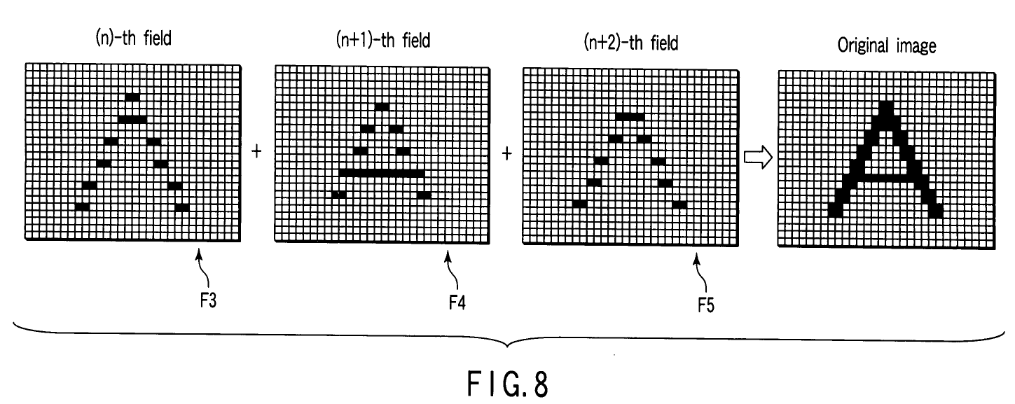

If the scanning line driving circuit 14 scans scanning lines SL1, SL4, SL7, . . . in the (n)-th field, scanning lines SL2, SL5, SL8, . . . in the (n+1)-th field, and scanning lines SL3, SL6, SL9, . . . in the (n+2)-th field as shown in FIG. 7, one screen is formed of three fields as shown in FIG. 8. In FIG. 8, a character image of “A” is formed of the (n)-th field F3, (n+1)-th field F4 and (n+2)-th field F5, and displayed.

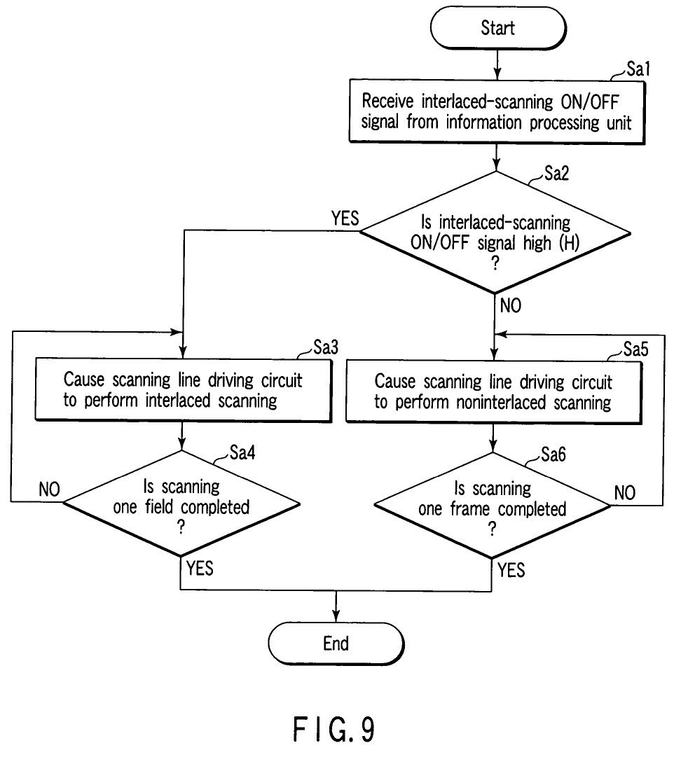

When one screen is formed of a plurality of fields as described above, the switching unit 16A switches between interlaced scanning and noninterlaced scanning during the vertical blanking interval. When the switching is performed during the vertical blanking interval, the switching unit 16A receives the interlaced scanning ON/OFF signal Si2 from the information processing unit 200 as shown in FIG. 9 (step Sa1). The switching unit 16A determines whether the received interlaced-scanning ON/OFF signal is an ON (H) signal or an OFF (L) signal (step Sa2). If it is an ON (H) signal, the switching unit 16A sends a drive signal to the scanning line driving circuit 14 for interlaced-scanning (step Sa3).

When the interlaced-scanning ON/OFF signal is an OFF (L) signal, the switching unit 16A sends a drive signal to the scanning line driving circuit 14 for noninterlaced scanning (step Sa5). When the circuit 14 performs interlaced scanning, the switching unit 16A determines whether interlaced scanning is completed for one field (step Sa4). If the interlaced-scanning for one field is not completed, it continues. If it is completed, the switching unit 16A waits for the next drive signal. When the circuit 14 performs noninter-laced scanning, the switching unit 16A determines whether noninterlaced scanning is completed for one frame (step Sa6). If the noninterlaced scanning for one frame is not completed, it continues. If it is completed, the switching unit 16A waits for the next drive signal.

In the first embodiment, as described above, noninterlaced-scanning is performed when the original image data Si(t) is a moving image and interlaced-scanning is performed when it is a still image. When a moving image is displayed, it is not blurred to be prevented from decreasing in quality. When a still image is displayed, the information processing unit 200 need not transmit all the original image data Si(t) to the display panel 100 to reduce power consumption. In conclusion, low power consumption can be achieved without decreasing the quality of a displayed image.

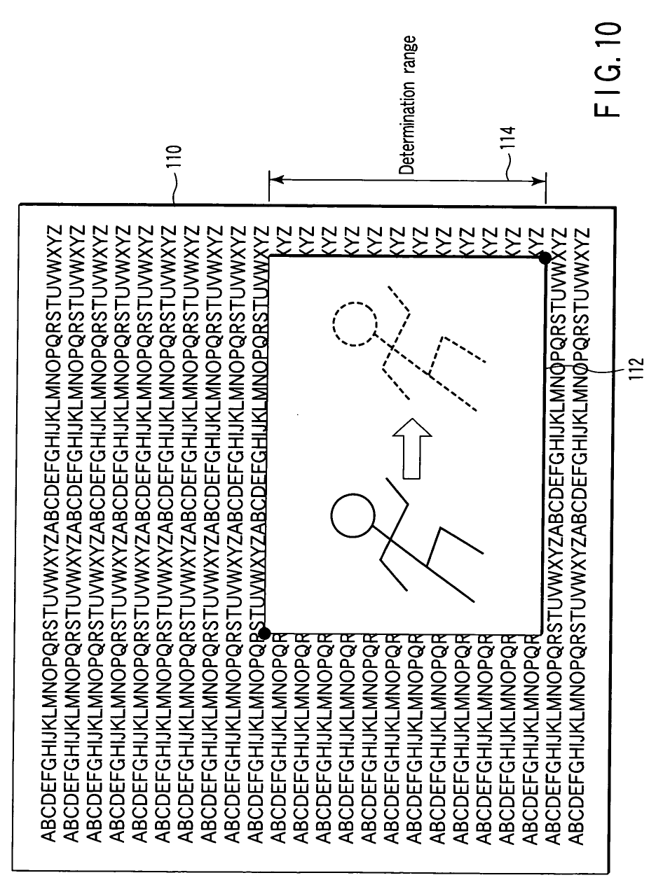

A second embodiment of the present invention will be described. As shown in FIG. 10, a still image is displayed as the background on a first display section 110, and a moving image is displayed on a second display section 112. In this case, it is determined whether the original image data Si(t) to be displayed on the second display section 112 is a moving image or not.

The original image data Si(t) is input to a display image control unit 22 and then to a data conversion circuit 22A, a frame memory 22C and a determination unit 24. The determination unit 24 includes a differential circuit 22B that calculates a difference between the original image data Si(t) and the one-field-old original image data Si(t-1) in a determination range 114, which is stored in the frame memory 22C.

The result obtained by the differential circuit 22B is input to a moving image determination unit 22D. The unit 22D calculates a sum of differences in the determination range 114 based on the input result. When the sum exceeds a given value, the unit 22D determines that the original image data Si(t) is a moving image. Then, the unit 22D determines an interlaced-scanning ON/OFF signal Si2 as an OFF signal and transmits it to a display line selection unit 22A2 of the data conversion circuit 22A and a switching unit 16A of a timing controller 16.

The moving image determination unit 22D determines that the original image data Si(t) is a still image when the sum of differences is not larger than the given value. Then, the unit 22D determines the signal Si2 as an ON signal and transmits it to the display line selection unit 22A2 and the switching unit 16A.

When the received interlaced-scanning ON/OFF signal is an OFF signal, the display line selection unit 22A2 outputs the original image data Si(t), which is received from a frame data delay unit 22A1, as image data Si1 and also outputs a first sync signal SiA as a second sync signal SiB.

When the received interlaced-scanning ON/OFF signal is an ON signal, the display line selection unit 22A2 selects image data Si1 corresponding to a scanning line to be driven from the original image data Si(t) received from the frame data delay unit 22A1, and outputs a sync signal corresponding to the image data Si1 as the second sync signal SiB.

The switching unit 16A causes a scanning line driving circuit 14 to interlaced-scan the scanning lines SL included in the determination range 114 when the interlaced-scanning ON/OFF signal Si2 received from the moving image determination unit 22D is an ON signal, or when the unit 22D determines that the original image data Si(t) displayed on the second display section 112 is a still image.

The switching unit 16A causes the scanning line driving circuit 14 to interlaced-scan the scanning lines SL included in the determination range 114 when the interlaced-scanning ON/OFF signal Si2 received from the unit 22D is an OFF signal, or when the unit 22D determines that the original image data Si(t) displayed on the section 112 is a moving image.

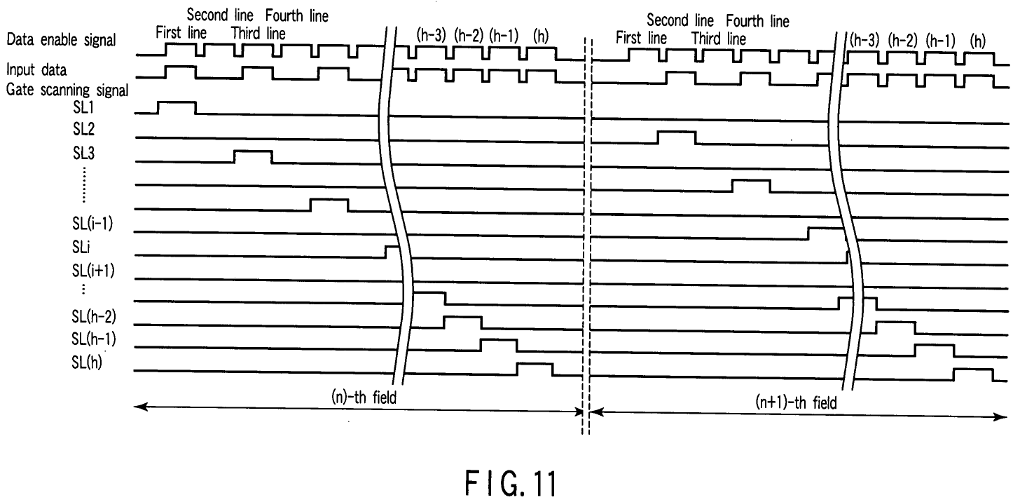

Referring to FIG. 11, the scanning lines SL are scanned at intervals of one line in the order designated as the first line, the third line, . . . , and the (i-1)-th line in the n-th field. This scanning is switched to noninterlaced scanning in which the scanning lines are scanned in sequence one by one, from the i-th line included in the determination range 114.

Further, the scanning lines SL are scanned at intervals of one line in the order designated as the second line, the fourth line, . . . in the (n+1)-th field. As in the n-th field, the interlaced scanning is performed to the (i-1)-th line and then changed to noninterlaced scanning from the i-th line included in the determination range 114.

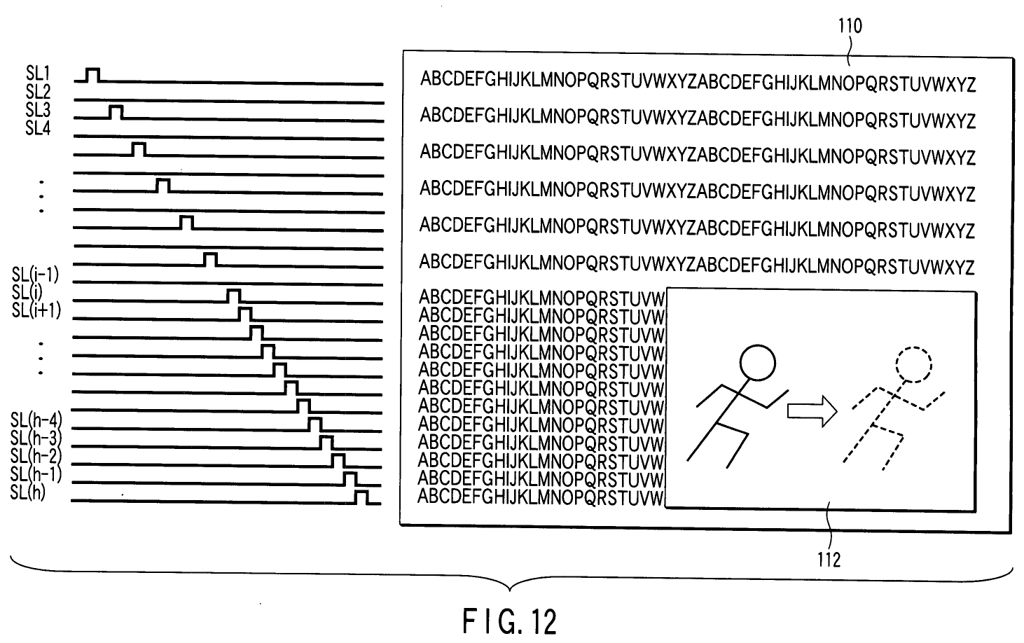

More specifically, as shown in FIG. 12, interlaced scanning is performed to form one screen of two fields from the first line to the (i-1)-th line, and thus the scanning lines SL, which are scanned at intervals of one line, are supplied with drive signals. All the scanning lines SL are scanned in sequence from the i-th line to the h-th line included in the determination range 114. In other words, all the scanning lines SL are supplied with drive signals since they are interlaced-scanned.

In the above case, the switching unit 16 switches between interlaced scanning and noninterlaced scanning during the horizontal blanking interval between scanning of the (i-1)-th line scanning line SL(i-1) and that of the i-th line scanning line SL(i).

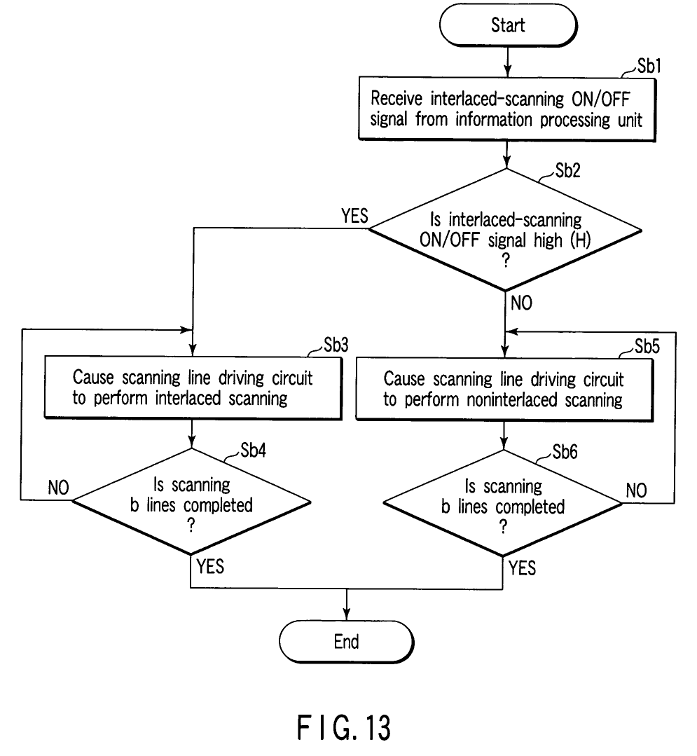

The switching unit 16A causes the scanning line driving circuit 14 to interlaced-scan the scanning lines SL included in a range other than the determination range 114 of the display section 110. To scan the scanning lines SL included in the determination range 114, the operation of the scanning line driving circuit 14 is switched as shown in the flowchart of FIG. 13. The switching unit 16A receives an interlaced-scanning ON/OFF signal Si2 from the information processing unit 200 (step Sb1).

The switching unit 16A determines whether the received interlaced-scanning ON/OFF signal Si2 is an ON(H) signal (step Sb2). If it is an ON(H) signal, the unit 16A transmits a drive signal to the scanning line driving circuit 14 to interlace-scan the scanning lines SL included in the determination range 114 (step Sb3). If it is an OFF(L) signal, the unit 16A transmits a drive signal to the scanning line driving circuit 14 to noninterlaced-scan the scanning lines SL included in the determination range 114 (step Sb5).

If the scanning lines SL included in the determination range 114 are b lines, the switching unit 16A determines whether the scanning for the b lines is completed (steps Sb4 and Sb6). If it is not completed, the interlaced scanning and noninterlaced scanning continue. When the scanning of the b lines is completed, the interlaced scanning and noninterlaced scanning end, and the scanning lines SL included in a range other than the determination range 114 are interlaced-scanned. Thus, the interlaced scanning and noninterlaced scanning are switched to each other within one field during the horizontal blanking interval before and after the determination range 114.

The determination of moving images in the above second embodiment can produce the same advantages as those of the first embodiment. The switching unit 16A switches the operation of the scanning line driving circuit 14 to interlaced-scan an area for displaying a still image and noninterlaced-scan an area for displaying a moving image within the same screen. Power consumption can thus be lowered more effectively than when the entire surface is interlaced-scanned.

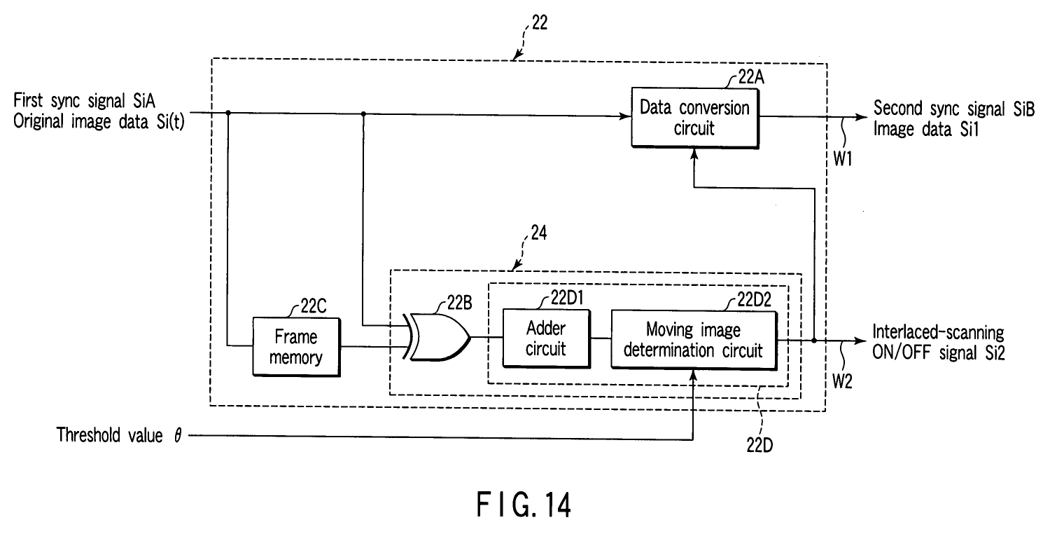

A third embodiment of the present invention will be described. As shown in FIG. 14, the moving image determination unit 22D includes a moving image determination circuit 22D2 that is supplied with a reference value θ from outside. The circuit 22D2 compares the reference value θ with a calculation result received from an adder circuit 22D1. The reference value θ varies with a power consumption mode set in an information processing unit 200.

When the power consumption mode is a “normal” mode, the reference value θ is set large. When it is a “power saving” mode, the reference value θ is set small.

The larger the variation of original image data Si(t) from one-frame-old original image data Si(t-1), the greater the calculation result of the adder circuit 22D1. In other words, the greater the calculation result of the adder circuit 22D1, the larger the power consumption.

Therefore, a determination result corresponding to a set power consumption mode can be obtained if a reference value θ corresponding to a preset power consumption mode is set for the calculation result of the adder circuit 22D1 and a moving image is determined according to whether the calculation result exceeds the reference value θ.

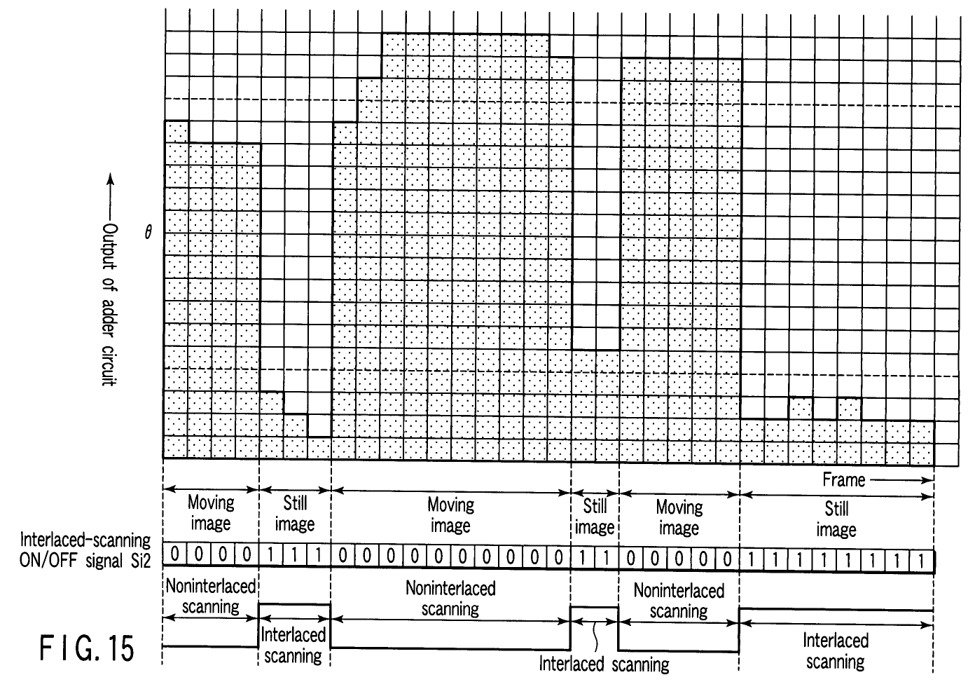

In the third embodiment, the maximum amount of variation of original image data Si(t) from each of all pixels PX is set to 100% and the reference value θ is set to 50%, as shown in FIG. 15. FIG. 15 shows variations of original image data Si(t) with original image data Si(t-1) in each frame, with the vertical axis indicative of calculation results of the adder circuit 22D1 input to the moving image determination circuit 22D2, and the horizontal axis indicative of time.

The moving image determination circuit 22D2 determines that the original image data Si(t) is a moving image if the sum of differences for each frame exceeds the reference value θ and that it is a still image if the sum is not larger than the reference value θ. The circuit 22D2 sets an interlaced-scanning ON/OFF signal Si2 to an OFF signal when the original image data Si(t) is a moving image and sets it to an ON signal when the data Si(t) is a still image. The circuit 22D2 transmits the interlaced-scanning ON/OFF signal Si2 so set to a data conversion circuit 22A and also to a timing controller 16 via a signal supply wire W2.

The data conversion circuit 22A selects image data Si1, which corresponds to a scanning line to be driven by a scanning line driving circuit 14, from the original image data Si in response to the interlaced-scanning ON/OFF signal Si2 from the moving image determination circuit 22D2, and transmits it to the timing controller 16 via a signal supply wire W1.

More specifically, when the input interlaced-scanning ON/OFF signal Si2 is an ON signal, the data conversion circuit 22A selects image data Si1, which corresponds to a scanning line to be driven by a scanning line driving circuit 14, from the original image data Si(t), and outputs a second sync signal SiB corresponding to the image data Si1. When the input interlaced-scanning ON/OFF signal Si2 is an OFF signal, the data conversion circuit 22A outputs the original image data Si(t) as image data Si1 and outputs a first sync signal SiA as the second sync signal SiB since the scanning line driving circuit 14 drives all scanning lines SL.

When the interlaced-scanning ON/OFF signal Si2 input to the timing controller 16 is an OFF signal, the switching unit 16A switches a drive signal to cause the scanning line driving circuit 14 to noninterlaced-scan the scanning lines. As shown in FIG. 4, the timing controller 16 causes the circuit 14 to scan the scanning lines SL in sequence to transmit pulses continuously to the first line to the h-th line in each frame. If the circuit 14 scans the scanning lines in this manner, one frame is formed of one screen.

When the interlaced-scanning ON/OFF signal Si2 is an ON signal, the switching unit 16A switches a drive signal to cause the scanning line driving circuit 14 to interlaced-scan the scanning lines. As shown in FIG. 5, the circuit 14 scans the scanning lines SL at intervals of one line. Image data corresponding to scanning lines to be driven is input to the signal lines DL.

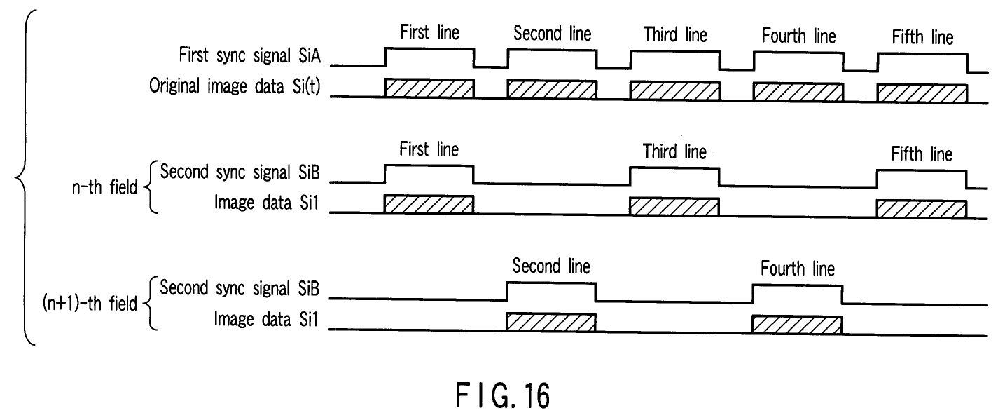

As shown in FIG. 16, in the n-th field, the scanning lines SL1, SL3, SL5, . . . of the first line, third line, fifth line, . . . are scanned, and image data corresponding to these scanning lines is input to the signal lines DL. In the (n+1)-th field, the scanning lines SL2, SL4, SL6, . . . of the second line, fourth line, sixth line, . . . are scanned, and image data corresponding to these scanning lines is input to the signal lines DL.

If the scanning line driving circuit 14 performs interlaced scanning as described above, one screen is formed of two fields of the n-th field and the (n+1)-th field (character image “A” is displayed in this case).

The switching unit 16A switches between interlaced scanning and noninterlaced scanning during the vertical blanking interval. A moving image determination operation of a display image control unit 22 and an operation of switching between interlaced scanning and noninterlaced scanning in the switching unit 16A will be described.

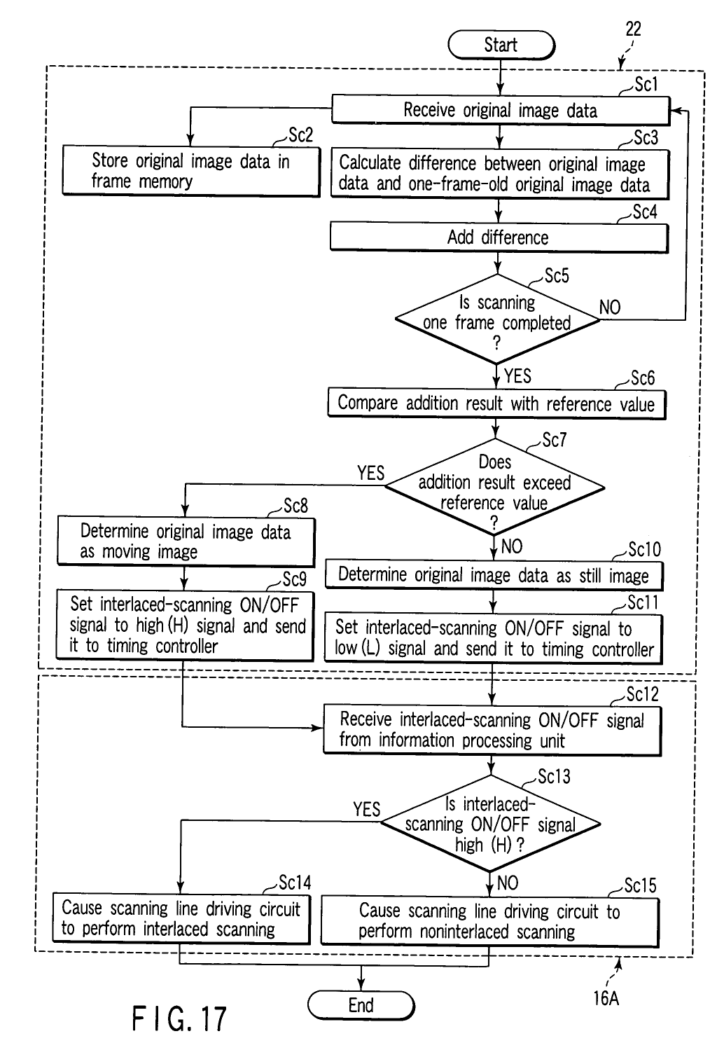

Referring to FIG. 17, the display image control unit 22 receives original image data Si(t) for each line (step Sc1). The original image data Si(t) is stored in a frame memory 22C (step Sc2), and a difference between the original image data Si(t) and one-frame-old original image data Si(t-1) read out of the frame memory 22C is calculated (step Sc3). This difference is added by the adder circuit 22D1 (step Sc4). This operation is repeated for original image data Si(t) for one frame (step Sc5).

The moving image determination circuit 22D2 compares the addition result of the adder circuit 22D1 with the reference value e input from outside (step Sc6). The circuit 22D2 determines whether the addition result exceeds the reference value e (step Sc7) and determines that the original image data Si(t) is a moving image when the addition result exceeds the reference value θ (step Sc8). The display image control unit 22 sets the interlaced-scanning ON/OFF signal to an OFF(L) signal and transmits it to the timing controller 16 (step Sc9).

When the addition result is not larger than the reference value θ, the circuit 22D2 determines that the original image data Si(t) is a still image (step Sc10). The display image control unit 22 sets the interlaced-scanning ON/OFF signal to an ON(H) signal and transmits it to the timing controller 16 (step Sc11).

The switching unit 16A receives an interlaced-scanning ON/OFF signal Si2 from the information processing unit 200 (step Sc12). The unit 16A determines whether the received signal Si2 is an ON(H) signal (step Sc13). If it is an ON(H) signal, the unit 16A transmits a drive signal to the scanning line driving circuit 14 such that the circuit 14 interlaced-scans the scanning lines (step Sc14). If it is an OFF(L) signal, the unit 16A transmits a drive signal to the scanning line driving circuit 14 such that the circuit 14 noninterlaced-scans the scanning lines (step Sc15).

According to the foregoing third embodiment, there can be provided a flat display device capable of determining whether the original image data Si(t) is a moving image using a reference value θ input from outside in accordance with a power consumption mode or the like, thereby lowering power consumption without decreasing the quality of a-displayed image.

As described above, noninterlaced scanning is performed when the original image data is determined as a moving image, and interlaced scanning is done when it is determined as a still image. When a moving image is displayed, it is not blurred to be prevented from decreasing in quality. When a still image is displayed, not all scanning lines need to be driven to lower power consumption.

When the scanning line driving circuit 14 performs interlaced scanning, not all the original image data Si(t) from the information processing unit 200 need to be transmitted to a display panel 100. The processing speed is not high. In interlaced scanning, the circuit 14 has to drive not all scanning lines SL in one field. Thus, power consumption can effectively be suppressed.

According to the present invention, low power consumption can be achieved without decreasing the quality of a displayed image.

In the above embodiments, a moving image is determined in the information processing unit 200. However, it can be done in the display panel 100. The same advantages as those of the above embodiments can be obtained.

In the foregoing embodiments, one screen is formed of two fields in interlaced scanning. One screen can be formed of two or more fields. For example, in the n-th field, the scanning lines can be scanned at intervals of j lines in the order designated as the {k+(j+1)}-th line, {k+2(j+1)}-th line, . . . . In the (n+1)-th field, the scanning lines can be scanned at intervals of j lines in the order designated as the (k+1)-th line, {k+1+(j+1)}-th line, {k+1+2(j+1)}-th line, . . . . If the interlaced scanning is performed in this manner, one screen is formed of j+1 fields.

In the above embodiments, the reference value θ is set in accordance with the power consumption mode. However, the reference value a can directly be varied with user's operations. In this case, the same advantages as those of the above embodiments can be obtained, and a user can set the reference value θ while confirming the quality of a displayed image.

In the second embodiment described above, a moving image is determined in the second display section 112. It can be done in both the display section 110 and the second display section 112. In this case, the flat display device includes a display image control unit to which the original image data of the display section 110 is input and a display image control unit to which the original image data of the second display section 112 is input. The switching unit 16A switches an operation of the scanning line driving circuit 14 in response to the interlaced scanning ON/OFF signal Si2 output from each of the display image control units.

Even though a moving image is displayed on the display section 110 serving as the background of the second display section 112, low power consumption can be achieved without decreasing the quality of a displayed image.

The display line selection unit 22A2 of the data conversion circuit 22A can be omitted from the display image control unit 22 in the foregoing embodiments. The original image data Si(t) is always transmitted to the switching unit 16A. The scanning line driving circuit 14 interlaced-scans the scanning lines to form one screen of a plurality of fields. In this case, too, the circuit 14 needs to drive not all the scanning lines SL in one field, with the result that low power consumption can be achieved without decreasing the quality of a displayed image.

In the third embodiment, interlaced scanning and noninterlaced scanning are switched to each other for each frame. As in the second embodiment, they can be switched within one frame. In this case, too, low power consumption can be achieved without decreasing the quality of a displayed image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flat display device comprising:
a plurality of pixels arranged in matrix on a substrate;
a plurality of scanning lines provided for respective rows of the pixels, which select a group of pixels in each of the rows;
a scanning line driving circuit to which the scanning lines are connected; and
a scanning switching circuit which determines whether input original image data is a still image or a moving image and switches an operation of the scanning line driving circuit to one of interlaced scanning and noninterlaced scanning in accordance with a determination result.

2. The flat display device according to claim 1, wherein the scanning switching circuit switches the operation of the scanning line driving circuit to the noninterlaced scanning when the original image data is determined as a moving image, and switches the operation of the scanning line driving circuit to the interlaced scanning when the original image data is determined as a still image.

3. The flat display device according to claim 1, wherein the scanning switching circuit is externally supplied with a reference value to determine whether the original image data is a moving image or a still image.

4. The flat display device according to claim 3, wherein the reference value varies with a power consumption mode.

5. The flat display device according to claim 1, wherein the scanning switching circuit calculates a difference between the original image data and one-frame-old image data, and determines that the original image data is a moving image when a sum of differences for one frame is larger than a given value and that the original image data is a still image when the sum is not larger than the given value.

6. The flat display device according to claim 1, wherein the scanning switching circuit calculates a difference between the original image data corresponding to a determination range and one-frame-old image data corresponding to the determination range, and determines that the original image data is a moving image when a sum of differences for the determination range is larger than a given value and that the original image data is a still image when the sum is not larger than the given value.

7. The flat display device according to claim 3, wherein the scanning switching circuit calculates a difference between the original image data and one-frame-old image data, and determines that the original image data is a moving image when a sum of differences for one frame is larger than the reference value and that the original image data is a still image when the sum is not larger than the reference value.

8. The flat display device according to claim 1, further comprising:
a plurality of signal lines provided for respective columns of the pixels, which supply an image signal to a group of pixels in each of the columns; and
a signal line driving circuit to which the signal lines are connected,
wherein the scanning switching circuit includes a display image control unit which determines whether the original image data is a moving image or a still image, and a switching unit which switches the operation of the scanning line driving circuit to one of the interlaced scanning and the noninterlaced scanning, and
the display image control unit includes a data conversion circuit which selects image data corresponding to a scanning line to be driven from the original image data, and supplies the switching unit with the selected image data and a sync signal thereof.

9. The flat display device according to claim 8, further comprising:
a display panel having the substrate; and
an information processing unit electrically connected to the display panel through a signal supply wire,
wherein the switching unit is provided in the display panel, and the display image control unit is provided in the information processing unit.

10. The flat display device according to claim 8, further comprising:
a display panel having the substrate; and
an information processing unit electrically connected to the display panel through a signal supply wire,
wherein the display image control unit and the switching unit are provided in the display panel.

11. The flat display device according to claim 1, wherein when the scanning line driving circuit performs the interlaced scanning, the scanning switching circuit scans the scanning lines at intervals of l lines in an order designated as {k+(j+1)}-th line, {k+2(j+1)}-th line, . . . in an n-th field, and scans the scanning lines at intervals of j lines in an order designated as (k+1)-th line, {k+1+(j+1)}-th line, {k+1+2(j+1)}-th line, . . . in an (n+1)-th field, to thereby form one screen.

12. The flat display device according to claim 1, wherein the switching unit switches between the interlaced scanning and the noninterlaced scanning within a same field.

13. The flat display device according to claim 1, wherein the switching unit switches between the interlaced scanning and the noninterlaced scanning during one of a vertical blanking interval and a horizontal blanking interval.

14. A method of driving a flat display device including a plurality of pixels arranged in matrix on a substrate, a plurality of signal lines provided for respective columns of the pixels, which supply an image signal to a group of pixels in each of the columns, a plurality of scanning lines provided for respective rows of the pixels, which select a group of pixels in each of the rows, a signal line driving circuit to which the signal lines are connected, a scanning line driving circuit to which the scanning lines are connected, and a scanning switching circuit to which original image data is input,
the method comprising:
determining whether the original image data is a still image or a moving image in the scanning switching circuit; and
switching an operation of the scanning line driving circuit to one of interlaced scanning and noninterlaced scanning in accordance with a determination result.

15. The method according to claim 14, wherein the scanning switching circuit switches the operation of the scanning line driving circuit to the interlaced scanning when the original image data is determined as a still image, and switches-the operation of the scanning line driving circuit to the noninterlaced scanning when the original image data is determined as a moving image.

16. The method according to claim 14, wherein the scanning switching circuit calculates a difference between the original image data and one-frame-old image data, and determines that the original image data is a moving image when a sum of differences for one frame exceeds a given value and that the original image data is a still image when the sum is not larger than the given value.

17. The method according to claim 14, wherein the scanning switching circuit calculates a difference between the original image data corresponding to a determination range and one-frame-old image data corresponding to the determination range, and determines that the original image data is a moving image when a sum of differences for the determination range exceeds a given value and that the original image data is a still image when the sum is not larger than the given value.

18. The method according to claim 14, wherein the scanning switching circuit is supplied with a reference value to determine whether the original image data is a moving image or a still image, the switching circuit calculates a difference between the original image data and one-frame-old image, compares a sum of differences for one frame with an external input reference value, and determines that the original image data is a moving image when the sum exceeds the reference value and that the original image data is a still image when the sum is not larger than the reference value.

19. The method according to claim 14, wherein the scanning switching circuit includes a display image control unit which determines whether the original image data is a moving image or a still image, and a switching unit which switches the operation of the scanning line driving circuit to one of the interlaced scanning and the noninterlaced scanning, and the display image control unit selects image data corresponding to a scanning line to be driven by the scanning line driving circuit from the original image data, and supplies the switching unit with the selected image data and a sync signal corresponding to the image data.

20. The method according to claim 14, wherein when the scanning line driving circuit performs the interlaced scanning, the scanning switching circuit scans the scanning lines at intervals of j lines in an order designated as {k+(j+1)}-th line, {k+2(j+1)}-th line, . . . in an n-th field, and scans the scanning lines at intervals of l lines in an order designated as (k+1)-th line, {k+1+(j+1)}-th line, {k+1+2(j+1)}-th line, . . . in an (n+1)-th field, to thereby form one screen.
